(19) United States
(12) Patent Application Publication
(10) Pub. No.: US 2025/0333306 A1
(43) Pub. Date: Oct. 30, 2025

(54) METHOD FOR PREPARING HIGH-PURITY LITHIUM SULFIDE THROUGH WET AND DRY PROCESSES

(71) Applicant: JS CHEM CORPORATION, Jeollabuk-do (KR)

(72) Inventors: Jae Won CHOI, Jeollabuk-do (KR); Seon Guk KIM, Jeollabuk-do (KR); Seok Hee IM, Sejong (KR); Yong Hyun KIM, Daegu (KR)

(73) Assignee: JS CHEM CORPORATION, Jeollabuk-do (KR)

(21) Appl. No.: 18/288,137

(22) PCT Filed: Nov. 23, 2022
(86) PCT No.: PCT/KR2022/018640

§ 371 Date: Dec. 11, 2024

(30) Foreign Application Priority Data
May 25, 2022 (KR) 10-2022-0063900

(51) Int. Cl. C01B 17/22

(52) U.S. Cl. CPC C01B 17/22; C01P 2002/72

(57) ABSTRACT

The present invention relates to a method of preparing high-purity lithium sulfide through wet and dry processes. More particularly, the present invention provides a lithium sulfide preparation method including a wet process of reacting lithium hydroxide (LiOH) with hydrogen sulfide (H₂S) gas in an organic solvent and a dry process of reacting a dried reaction product resulting from the wet process with hydrogen sulfide (H₂S) gas. The lithium sulfide preparation method enables mass production of lithium sulfide.

### TECHNICAL FIELD

The present invention relates to a method for preparing high-purity lithium sulfide through wet and dry processes.

### BACKGROUND ART

Lithium-sulfur rechargeable batteries have a theoretical energy density of 2,800 Wh/kg (1,675 mAh/g), which is much higher than that of currently commercialized lithium rechargeable batteries, and sulfur-based materials used as cathode active materials are abundant, inexpensive, and environmentally friendly.

In such a lithium-sulfur secondary battery, lithium metal used as an anode material has a problem of growing into a dendrite phase while lithium metal dissociates into lithium ions, and the lithium ions change back to as a lithium metal precipitate during the charging and discharging of the battery, thereby causing a short circuit in the battery, which is a factor that lowers the stability of the battery.

In addition, to activate sulfur in a lithium-sulfur secondary battery, formation of a composite with carbon is required. However, since the sublimation temperature of sulfur is low (˜115° C.), an ampoule always needs to be used. Moreover, even though such an ampoule is used, the degree of carbon adsorption is significantly low, and the same process must be repeated several times to achieve the adequate level of sulfur loading density, resulting in high process costs.

To fundamentally solve the problem of lithium-sulfur secondary batteries, it has been proposed to use lithium sulfide (Li₂S) rather than sulfur as a cathode material. When lithium sulfide is used as a cathode material, it is not necessary to use lithium metal as an anode, and its high melting temperature (˜1000° C.) allows the filling rate of the cathode to be adjusted to a desired level. Therefore, batteries can be easily manufactured. In addition, because of the high melting temperature, various kinds of post-treatment processes can be performed at high temperatures. These post-treatment processes have the advantage of maximizing the activity of lithium sulfide.

On the other hand, unlike conventional lithium ion batteries using liquid electrolytes, all-solid-state batteries (ASSB) using solid electrolytes are safer than conventional lithium-ion batteries because they do not have problems such as flammability, corrosion, leakage, and evaporation caused by liquid electrolytes, and they can be used in a wide range of temperatures.

An all-solid-state lithium secondary battery is composed of a cathode, an anode, and a solid electrolyte. Solid electrolytes are largely classified into polymer, oxide, and sulfide. Among them, oxide-based solid electrolytes and sulfide-based solid electrolytes, which have relatively high ionic conductivity, excellent mechanical properties, and nonflammability, have been actively studied.

Since lithium sulfide (Li₂S) used as a material for such a sulfide-based solid electrolyte is produced through synthesis because it does not exist as a natural mineral.

One of the conventional synthesis methods for lithium sulfide is the reaction of lithium hydroxide (LiOH) and hydrogen sulfide, which is a gaseous sulfur source. Japanese Patent Application Publication No. 1997-278423 discloses a method of preparing lithium sulfur using a dry process. In the method, lithium hydroxide particles are pulverized to have particle sizes of 0.1 to 1.5 mm, and lithium hydroxide and hydrogen sulfide are then reacted at elevated temperature of 80° C. to 445° C. in an inert gas atmosphere.

However, in the dry lithium sulfide preparation method described above, since lithium hydroxide is highly hygroscopic, lithium hydroxide easily agglomerates. Therefore, it is difficult to handle lithium hydroxide in large quantities, it is not easy to process the obtained lithium sulfide into fine particles, and it is difficult to mass-produce lithium sulfide.

### DISCLOSURE

### Technical Problem

To solve the above problems, the present invention aims to provide a lithium sulfide preparation method by which high purity lithium sulfide can be mass-produced.

However, the above objective is illustrative, and the technical spirit of the present disclosure is not limited thereto.

### Technical Solution

One aspect of the present invention for achieving the above objective is to provide a method of preparing lithium sulfide, the method including: a) allowing a primary reaction at a pressure higher than normal pressure by raising a temperature of a reaction solution containing lithium hydroxide (LiOH) and an organic solvent to 100° C. or above and then injecting hydrogen sulfide (H₂S) gas into the reaction solution; b) allowing a secondary reaction one more times by injecting hydrogen sulfide (H₂S) gas when an internal pressure of a reactor returns to normal pressure after step a; c) obtaining a primary reaction product by removing the organic solvent from the reaction solution after step b); d) allowing a tertiary reaction at a pressure higher than normal pressure by raising a temperature of the primary reaction product to 100° C. or above and then injecting hydrogen sulfide (H₂S) gas; and e) allowing a quaternary reaction, one or more times after step d, by removing water, which is a reaction by-product, using a vacuum pump and then injecting hydrogen sulfide (H₂S) gas.

In the aspect, step a) and step b) may be independently performed at a reaction temperature of 100° C. to 150° C.

In the aspect, the organic solvent may be a solvent mixture of two or more solvents selected from an aromatic organic solvent, an amide-based organic solvent, and a sulfur-containing organic solvent. Specifically, for example, the aromatic organic solvent may be at least one selected from alkylbenzene, dialkylbenzene, alkylnaphthalene, dialkylnaphthalene, alkylbiphenyl, and dialkylbiphenyl. The amide-based organic solvent may be one type selected from N-methyl-2-pyrrolidone (NMP), N,N′-dimethylacetamide (DMAc), hexamethylphosphoamide (HMPA), and N,N-dimethylformamide (DMF). The sulfur-containing organic solvent may be one or more sulfite-based solvents selected from alkylene sulfite, dialkyl sulfite, diaryl sulfite, and alkyl aryl sulfite.

In the aspect, the volume ratio of the aromatic organic solvent to the sulfur-containing organic solvent in the mixed solvent may be in a range of 1:0.1 to 1:10.

In the aspect, the concentration of lithium hydroxide (LiOH) in the reaction solution may be in a range of 0.1 to 10 M.

In the aspect, step b) may be performed 10 to 100 times.

In the aspect, step d) and step e) may be independently performed at a reaction temperature of 100° C. to 150° C.

In the aspect, step d) and step e) may involve injection of an inert gas together with the hydrogen sulfide (H₂S) gas, and specifically, for example, the inert gas may be at least one selected from argon (Ar), helium, (He) and nitrogen (N2).

### Advantageous Effects

The lithium sulfide preparation method according to the present invention has the advantage of being able to mass-produce high-purity lithium sulfide by primarily reacting a reaction solution containing lithium hydroxide (LiOH) and an organic solvent with hydrogen sulfide through a wet process, and then secondarily reacting a primary reaction product resulting from the primary reaction with hydrogen sulfide through a dry process.

### DESCRIPTION OF DRAWINGS

FIG. 1 is an X-ray diffraction (XRD) pattern analysis result of lithium sulfide (LigS) prepared through wet and dry processes according to Example 1.

FIG. 2 is an X-ray diffraction (XRD) pattern analysis result of lithium sulfide (Li₂S) prepared through a wet process according to Comparative Example 1.

### BEST MODE

A high-purity lithium sulfide preparation method using wet and dry processes, according to the present invention, will be described in detail below. The following drawings are provided as examples to sufficiently convey the spirit of the present disclosure to those skilled in the art. Accordingly, the present disclosure is not limited to the drawings and may be embodied in other forms, and the drawings presented below may be exaggerated to clarify the spirit of the present disclosure. In the flowing description, unless otherwise defined, all terms including technical and scientific terms used herein have the same meaning as commonly understood by those who are ordinarily skilled in the art to which this disclosure belongs. Further, when it is determined that the detailed description of the known art related to the present disclosure might obscure the gist of the present disclosure, a detailed description thereof will be omitted.

One aspect of the present invention for achieving the above objective is to provide a method of preparing lithium sulfide, the method including: a) allowing a primary reaction at a pressure higher than normal pressure by raising a temperature of a reaction solution containing lithium hydroxide (LiOH) and an organic solvent to 100° C. or above and then injecting hydrogen sulfide (H₂S) gas into the reaction solution; b) allowing a secondary reaction one more times by injecting hydrogen sulfide (H₂S) gas when an internal pressure of a reactor returns to normal pressure after step a; c) obtaining a primary reaction product by removing the organic solvent from the reaction solution after step b); d) allowing a tertiary reaction at a pressure higher than normal pressure by raising a temperature of the primary reaction product to 100° C. or above and then injecting hydrogen sulfide (H₂S) gas; and e) allowing a quaternary reaction, one or more times after step d, by removing water, which is a reaction by-product, using a vacuum pump and then injecting hydrogen sulfide (H₂S) gas.

The lithium sulfide preparation method according to the present invention has the advantage of being able to mass-produce high-purity lithium sulfide by primarily reacting a reaction solution containing lithium hydroxide (LiOH) and an organic solvent with hydrogen sulfide through a wet process, and then secondarily reacting a primary reaction product resulting from the primary reaction with hydrogen sulfide through a dry process.

Hereinafter, each process involved in the lithium sulfide preparation method according to one embodiment of the present invention will be described in detail.

First, at step a), a reaction solution containing lithium hydroxide (LiOH) and an organic solvent is heated to 100° C. or above, and then hydrogen sulfide (H₂S) gas is injected to cause a reaction at a pressure higher than normal pressure.

In one embodiment of the present invention, the reaction solution is obtained by dissolving lithium hydroxide in an organic solvent. Specifically, for example, the organic solvent may be a solvent mixture in which two or more solvents selected from an aromatic organic solvent, an amide-based organic solvent, and a sulfur-containing organic solvent are mixed. Preferably, when a solvent mixture of an aromatic organic solvent and a sulfur-containing organic solvent is used as a reaction solvent, the reaction between lithium hydroxide and hydrogen sulfide is more actively carried out, so that lithium sulfide can be effectively synthesized, and the purity of the obtained lithium sulfide can be further improved.

Specifically, for example, the aromatic organic solvent may be at least one selected from alkylbenzene, dialkylbenzene, alkylnaphthalene, dialkylnaphthalene, alkylbiphenyl, and dialkylbiphenyl. In this case, the alkyl may mean an alkyl group having 1 to 6 carbon atoms and more preferably 1 to 3 carbon atoms. More specifically, for example, the aromatic the organic solvent may be at least one selected from toluene, ethylbenzene, isopropylbenzene, xylene, diethylbenzene, diisopropylbenzene, methylnaphthalene, dimethylnaphthalene, ethylbiphenyl, and diethylbiphenyl. In this case, when two alkyl groups are present, the aromatic solvent may be any one of ortho, meta, and para forms.

The amide-based organic solvent may be at least one N-methyl-2-pyrrolidone selected from (NMP), N,N′-dimethylacetamide (DMAc), hexamethylphosphoramide (HMPA), and N,N-dimethylformamide (DMF).

In addition, the sulfur-containing organic solvent may be one or more sulfite-based solvents selected from alkylene sulfite, dialkyl sulfite, diaryl sulfite, and alkyl aryl sulfite. In this case, the alkyl or alkylene may mean an alkyl group or alkylene group having 1 to 6 carbon atoms and more preferably 1 to 3 carbon atoms, and the aryl may mean an aryl group having 6 to 20 carbon atoms. More specifically, for example, the sulfite-based solvent may be at least one selected from ethylene sulfite, propylene sulfite, butylene sulfite, dimethyl sulfite, diethyl sulfite, dipropyl sulfite, dibutyl sulfite, methyl phenyl sulfite, ethyl phenyl sulfite, methyl benzyl sulfite, and ethyl benzyl sulfite.

In addition, as described above, when a solvent mixture in which an aromatic organic solvent and a sulfur-containing organic solvent are mixed is used as the reaction solvent, the reaction between lithium hydroxide and hydrogen sulfide more actively occurs, so that lithium sulfide can be effectively synthesized, and the purity of the produced lithium sulfide can be improved. Accordingly, it is preferable to use a solvent mixture in which an aromatic organic solvent and a sulfur-containing organic solvent are mixed, as the reaction solvent.

Specifically, for example, the volume ratio of the aromatic organic solvent to the sulfur-containing organic solvent in the solvent mixture may be 1:0.1 to 1:10, preferably 1:0.2 to 1:3, and more preferably 1:0.3 to 1:1. When the mixed solution is prepared to satisfy the range, the effect of promoting the reaction is excellent.

Meanwhile, the concentration of lithium hydroxide (LiOH) in the reaction solution may be in a range of 0.1 to 10 M, and more preferably a range of 1 to 5 M. With the range being satisfied, lithium hydroxide and hydrogen sulfide well react to synthesize lithium sulfide.

In addition, in one embodiment of the present invention, step a) may be carried out at a reaction temperature in a range of 100° C. to 150° C., and more preferably at a reaction temperature in a range of 110° C. to 130° C. With the range being satisfied, lithium hydroxide and hydrogen sulfide well react to synthesize lithium sulfide.

In addition, the normal pressure may mean 1 to 1.5 atm, and preferably, 1 to 1.2 atm. A pressure higher than the normal pressure may mean a pressure higher than 1.5 atm, for example, 2 to 10 atm.

Next, at step b), when the internal pressure of a reactor changes back to the normal pressure after step a), hydrogen sulfide (H₂S) gas is injected into the reaction solution to cause a reaction. Step b) may be performed one or more times.

That is, when the internal pressure of the reactor is lowered back to the normal pressure (1 to 1.5 atm) due to the synthesis of lithium sulfide after the injection of hydrogen sulfide gas at step a), the process of injecting hydrogen sulfide (H₂S) gas to cause a reacting again may be performed one or more times, preferably 10 to 100 times, and more preferably 30 to 50 times. By repeating the process of injecting hydrogen sulfide gas and causing a reaction several times, most of the lithium hydroxide can be converted into lithium sulfide.

In this case, step b) may also be performed at a reaction temperature in a range of 100° C. to 150° C., and more preferably at a reaction temperature in a range of 110° C. to 130° C. With the range being satisfied, lithium hydroxide and hydrogen sulfide well react to synthesize lithium sulfide.

Next, at step c), the organic solvent of the reaction solution is removed after step b), thereby producing a primary reaction product. The method for removing the organic solvent is not particularly limited. For example, the organic solvent can be removed, for example, through an evaporation drying method.

Thereafter, a dry process may be additionally performed to completely convert a small amount of the remaining unreacted lithium hydroxide to lithium sulfide. That is, at step d), the primary reaction product is heated to a temperature of 100° C., and hydrogen sulfide (H₂S) gas is injected to cause a reaction at a pressure higher than normal pressure. At step e), water as a reaction by-product is removed using a vacuum pump after step d), and hydrogen sulfide (H₂S) gas is injected to cause a reaction again. The consecutive steps d) and e) are repeatedly performed one or more times.

In this case, step d) and step e) may also be performed at a reaction temperature in a range of 100° C. to 150° C., and more preferably in a range of 120° C. to 140° C. With the range being satisfied, lithium hydroxide and hydrogen sulfide well react, so that lithium sulfide with high purity can be obtained.

In one example of the present invention, at step d) and step e), an inert gas may be further injected together with the hydrogen sulfide (H₂S) gas. In this case, the inert gas may be (Ar), helium (He), and at least one selected from argon nitrogen (N2).

In this case, the volume ratio of the hydrogen sulfide (H₂S) gas and the inert gas may be in a range of 1:0.1 to 1:10, and more preferably a range of 1:0.5 to 1:3. With the range being satisfied, lithium hydroxide and hydrogen sulfide well react, so that lithium sulfide with high purity can be obtained.

Meanwhile, after the process of injecting and re-reacting hydrogen sulfide gas, water generated as a reaction by-product needs to be removed. When the water is not removed, unreacted lithium hydroxide may remain as an impurity. In this case, the method of removing the water is not particularly limited. For example, a vacuum pump can be used to remove the water.

Step e) may be repeatedly performed until moisture does not form while the progress of the reaction is observed through a sight glass. After the completion of the reaction, lithium sulfide is preferably obtained from a glove box.

As described above, after the wet process involving steps a) to c) is performed, the dry process involving steps d) to e) is performed. In this way, it is possible to prepare high-purity lithium sulfide by mass production. In this case, the purity of the obtained lithium sulfide can be 99.9% or more, preferably 99.93% or more, and more preferably 99.95% or more. In addition, the upper limit of the purity may be 100% ideally but may be 99.999% in reality.

Hereinafter, examples of the present invention will be described. Through the examples, a high-purity lithium sulfide preparation method using wet and dry processes, according to the present invention, will be more clearly understood. However, the examples described above are presented only for illustrative purposes and are intended to limit the present invention. The present invention can be embodied in other forms in addition to the forms presented by the examples.

In addition, unless otherwise defined, all technical and scientific terms have the same meaning as that is generally understood by the ordinarily skilled in the art to which the present invention pertains. The terms used in the description of the specification of the present application are only intended to effectively describe specific examples and are not intended to limit the present invention. The units of the amounts of additives, which are not specifically stated herein, may be & by weight.

### EXAMPLE 1

### Wet+Dry

After putting 350 ml of p-xylene, 150 ml of ethylene sulfite, and 25 g of lithium hydroxide (LiOH) in a 2-L reactor, the reactants were heated to a temperature of 110° C. When the temperature reached 110° C., 4 L of hydrogen sulfide (H₂S) was injected into the reactor, and then 2 L of H₂S was additionally injected into the reactor while stirring at 50 rpm. The process in which the reaction mixture was continuously stirred until the internal pressure increases to normal pressure (1 atm) by the excessively injected H₂S, and then 2L of H₂S was additionally injected into the reactor was repeated 40 times.

Thereafter, the solvent mixture in the reaction solution was removed, followed by drying through an evaporation drying process, to obtain a primary reaction product. Subsequently, the primary reaction product was added to a 2-L reactor to remove the remaining unreacted LiOH from the dried primary reaction product. Next, while stirring at 130° C. at 50 rpm, 5 L of argon (Ar) and 7 L of H₂S were injected into the reactor, and the reactants were reacted for 1 min after the injection. Next, water, which is a reaction by-product, and the remaining gas were removed through vacuuming. While observing the inside of the reactor through a sight glass, the process was repeated until moisture did not form. After completion of the reaction, lithium sulfide (Li₂S) was collected from the glove box.

### EXAMPLE 2

All the processes were performed in the same manner as in Example 1, except that 500 ml of p-xylene was used as the reaction solvent.

### EXAMPLE 3

All the processes were performed in the same manner as in Example 1, except that 400 ml of p-xylene and 100 ml of ethylene sulfite were used as the reaction solvent.

### EXAMPLE 4

All the processes were performed in the same manner as in Example 1, except that 250 ml of p-xylene and 250 ml of ethylene sulfite were used as the reaction solvent.

### EXAMPLE 5

All the processes were performed in the same manner as in Example 1, except that 150 ml of p-xylene and 350 ml of ethylene sulfite were used as the reaction solvent.

### EXAMPLE 6

All the processes were performed in the same manner as in Example 1, except that 500 ml of ethylene sulfite was used as the reaction solvent.

### COMPARATIVE EXAMPLE 1

### Wet

After putting 350 ml of p-xylene, 150 ml of ethylene sulfite, and 25 g of lithium hydroxide (LiOH) in a 2-L reactor, the reactants were heated to a temperature of 110° C. When the temperature reached 110° C., 4 L of hydrogen sulfide (H₂S) was injected into the reactor, and 2 L of H₂S was then additionally injected into the reactor under stirring at 50 rpm. The process in which the reaction mixture was continuously stirred until the internal pressure increases to normal pressure (1 atm) by the excessively injected H₂S, and then 2L of H₂S was additionally injected into the reactor was performed 40 times.

Next, the solvent mixture was removed, followed by drying using an evaporation drying method, to obtain lithium sulfide (Li₂S).

### COMPARATIVE EXAMPLE 2

### Dry

After adding 25 g of LiOH to a 2-L reactor, 5 L of Ar and 7 L of H₂S were injected into the reactor under stirring at 50 rpm, and reacted for 1 min after the injection. Subsequently, water, which is a reaction by-product, and the remaining gas were removed through vacuuming. While observing the inside of the reactor through a sight glass, the process was repeated until moisture did not form. After the completion of the reaction, lithium sulfide (Li₂S) was collected from the glove box.

### [Evaluation of Properties]

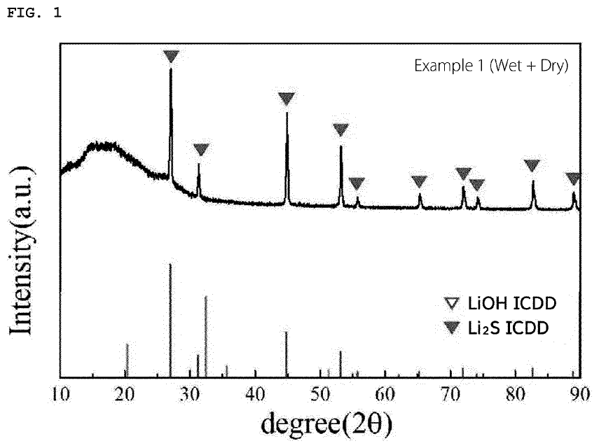

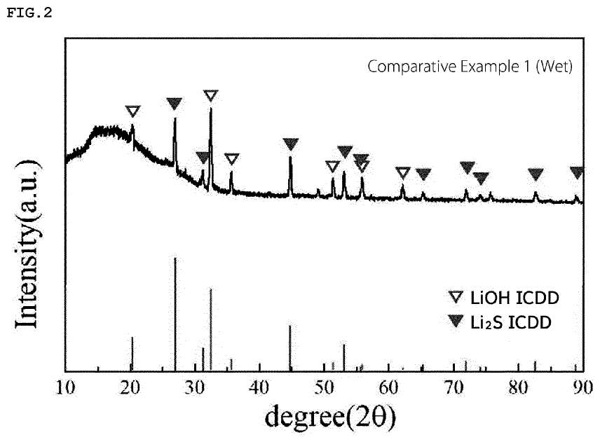

X-ray diffraction (XRD) patterns of the lithium sulfides (Li₂S) prepared according to Example 1 and Comparative Example 1 were analyzed. The results are shown in FIGS. 1 and 2.

Referring to FIG. 1, in the case of Example 1 in which both the wet process and the dry process were performed according to the present invention, it was confirmed that lithium sulfide with high purity and without impurities was obtained.

On the other hand, referring to FIG. 2, in the case of the end product of Comparative Example 1 in which the product was prepared only by the wet process, it was found that a large amount of lithium hydroxide (LiOH) remained unreacted. In addition, peaks of impurities other than lithium sulfide and lithium hydroxide were also detected, meaning that the purity of the lithium sulfide was low.

The lithium sulfides (Li₂S) prepared according to Examples 1 to 6 and Comparative Example 2 were analyzed for purity through inductively coupled plasma spectroscopy (ICP-OES) and energy dispersive analysis of X-ray (EDAX). The purity was measured for each of three samples for each of the lithium sulfides. The average of the measured values of the three samples was taken as the purity of each lithium sulfide. The results are shown in Table 1 below.

TABLE 1

Purity (%)

| | 1 | 2 | 3 | Average |
|---|---|---|---|---|
| Example 1 | 99.982 | 99.975 | 99.991 | 99.983 |
| Example 2 | 99.913 | 99.894 | 99.921 | 99.909 |
| Example 3 | 99.936 | 99.928 | 99.957 | 99.940 |
| Example 4 | 99.989 | 99.974 | 99.972 | 99.978 |
| Example 5 | 99.948 | 99.933 | 99.918 | 99.933 |
| Example 6 | 99.832 | 99.817 | 99.869 | 99.839 |
| Comparative | 99.745 | 99.798 | 99.815 | 99.786 |
| Example 2 | | | | |

Referring to Table 1 above, it is found that when a mixture of p-xylene and ethylene sulfite is used as the reaction solvent, the purity is more excellent than other cases. When p-xylene and ethylene sulfite are mixed in a volume ratio in a range of 1:0.2 to 1:3, it is confirmed that the purity is especially excellent.

The present invention has been described with reference to some specific examples and characters. However, the specific examples and characteristics are only for illustrative purposes and are intended to limit the scope of the present invention, and it will be appreciated that various modifications and changes are possible from the above description by those skilled in the art to which the present invention pertains.

Therefore, the spirit of the present invention is not limited to the specific examples described above, and all forms defined by the appended claims and all equivalents and modifications thereto fall within the scope of the present invention.

1. A method of preparing lithium sulfide, the method comprising:
a) allowing a primary reaction at a pressure higher than normal pressure by raising a temperature of a reaction solution containing lithium hydroxide (LiOH) and an organic solvent to 100° C. or above and then injecting hydrogen sulfide (H₂S) gas into the reaction solution;
b) allowing a secondary reaction, one or more times after step a), by additionally injecting hydrogen sulfide (H₂S) gas into the reaction solution when an internal pressure of a reactor returns to normal pressure;
c) obtaining a primary reaction product by removing the organic solvent from the reaction solution after step b);
d) allowing a tertiary reaction at a pressure higher than normal pressure by raising a temperature of the primary reaction product to 100° C. or above and then injecting hydrogen sulfide (H₂S) gas; and
e) allowing a quaternary reaction, one or more times after step d), by removing water, which is a reaction by-product, using a vacuum pump and injecting hydrogen sulfide (H₂S) gas again.

2. The method of claim 1, wherein step a) and step b) are independently performed at a reaction temperature in a range of 100° C. to 150° C.

3. The method of claim 1, wherein the organic solvent is a solvent mixture of two or more solvents selected from an aromatic organic solvent, an amide-based organic solvent, and a sulfur-containing organic solvent.

4. The method of claim 3, wherein the aromatic organic solvent is at least one selected from among alkylbenzenes, dialkylbenzenes, alkylnaphthalenes, dialkylnaphthalenes, alkylbiphenyls, and dialkylbiphenyls.

5. The method of claim 3, wherein the amide-based organic solvent is at least one selected from among N-methyl-2-pyrrolidone (NMP), N,N′-dimethylacetamide (DMAC), hexamethylphosphoramide (HMPA), and N,N-dimethylformamide (DMF).

6. The method of claim 3, wherein the sulfur-containing organic solvent is a sulfite-based solvent.

7. The method of claim 6, wherein the sulfite-based solvent is at least one selected from alkylene sulfite, dialkyl sulfite, diaryl sulfite, and alkyl aryl sulfite.

8. The method of claim 3, wherein in the solvent mixture, the aromatic organic solvent and the sulfur-containing organic solvent are mixed in a volume ratio in a range of 1:0.1 to 1:10.

9. The method of claim 1, wherein in the reaction solution, the lithium hydroxide (LiOH) is contained at a concentration in a range of 0.1 to 10 M.

10. The method of claim 1, wherein step b) is repeatedly performed 10 to 100 times.

11. The method of claim 1, wherein step a) and step e) are independently performed at a reaction temperature in a range of 100° C. to 150° C.

12. The method of claim 1, wherein in steps d) and e), an inert gas is further injected together with the hydrogen sulfide (H2S) gas.

13. The method of claim 12, wherein the inert gas is at least one selected from argon (Ar), helium (He), and nitrogen (N₂).
